(19) United States
(12) Patent Application Publication
(10) Pub. No.: US 2026/0302158 A1
(43) Pub. Date: Oct. 1, 2026

(54) METHOD FOR CONTINUOUS INTERMITTENT EXTRUSION AND LAMINATION OF LITHIUM METAL FOIL FOR BATTERY ELECTRODES

(71) Applicant: Soelect Inc., Greensboro, NC (US)

(72) Inventor: Sungjin Cho, Summerfield, NC (US)

(21) Appl. No.: 19/578,526

(22) Filed: Mar. 25, 2026

Related U.S. Application Data
(60) Provisional application No. 63/777,335, filed on Mar. 25, 2025.

(51) Int. Cl. H01M 4/04; H01M 4/38; H01M 4/66; H01M 4/02; H01M 10/052

(52) U.S. Cl. CPC H01M 4/0409; H01M 4/0404; H01M 4/0411; H01M 4/0414; H01M 4/0435; H01M 4/0471; H01M 4/382; H01M 4/661; H01M 2004/021; H01M 10/052

(57) ABSTRACT

A method for manufacturing a lithium metal electrode is disclosed. The method includes depositing lithium metal onto an intermediate carrier layer to form discrete lithium metal regions that are positioned at predetermined intervals along the intermediate carrier layer, and compressing the discrete lithium metal regions to form thin lithium metal foil segments on the intermediate carrier layer via plastic deformation and elongation. The method further includes laminating the thin lithium metal foil segments onto a substrate by passing the intermediate carrier layer, the thin lithium metal foil segments, and the substrate through a compression device to adhere the thin lithium metal foil segments to the substrate. The method also includes removing the intermediate carrier layer to form a lithium metal electrode comprising a plurality of thin lithium metal foil segments adhered to the substrate and separated from one another by designed gaps resulting from the predetermined intervals.

### CROSS-REFERENCE TO RELATED APPLICATIONS

This application claims priority to U.S. Provisional Patent Application No. 63/777,335, filed on Mar 25, 2025, the disclosure of which is incorporated herein by reference in its entirety.

### TECHNICAL FIELD

The present disclosure relates generally to lithium metal electrodes for electrochemical cells. More particularly, the disclosure relates to manufacturing methods for producing thin lithium metal foil intermittently laminated onto a substrate through a continuous extrusion, compression, and lamination processes.

### BACKGROUND

Lithium metal has long been considered a highly promising anode material for next generation rechargeable batteries due to its extremely high theoretical capacity and low electrochemical potential. Despite these advantages, practical implementation of lithium metal anodes remains challenging due to difficulties associated with manufacturing and stability.

Conventional lithium metal electrode manufacturing typically begins with a lithium metal ingot. The ingot is extruded into a thick sheet using a hydraulic press and subsequently compressed multiple times through a rolling process to produce thin lithium metal foil suitable for battery applications. After the thin lithium foil is produced, it is slit and cut into individual pieces before being laminated onto a substrate.

This conventional process suffers from several significant disadvantages. First, the extrusion of lithium metal ingots requires high mechanical force and substantial energy consumption. Hydraulic extrusion presses are large and expensive pieces of equipment that significantly increase manufacturing cost and facility footprint. Second, the ingot extrusion process typically exhibits relatively low material utilization. Residual lithium metal often remains inside the extrusion chamber after processing, which leads to material losses and reduced yield.

Third, the need for slitting operations introduces additional processing steps and equipment. Slitting also reduces manufacturing throughput and increases production complexity.

Fourth, the conventional approach offers limited flexibility in electrode design. Lithium foil produced through continuous rolling must be subsequently cut and positioned, which makes it difficult to control precise placement and spacing of lithium regions on the final electrode substrate.

Accordingly, there remains a need for improved lithium metal manufacturing processes that reduce energy consumption, simplify processing steps, increase material utilization, and provide improved control over lithium electrode geometry.

### SUMMARY

In some embodiments, the disclosed subject matter includes a method for manufacturing a lithium metal electrode. The method includes depositing lithium metal onto an intermediate carrier layer to form discrete lithium metal regions that are positioned at predetermined intervals along the intermediate carrier layer, and compressing the discrete lithium metal regions to form thin lithium metal foil segments on the intermediate carrier layer via plastic deformation and elongation. The method further includes laminating the thin lithium metal foil segments onto a substrate by passing the intermediate carrier layer, the thin lithium metal foil segments, and the substrate through a compression device to adhere the thin lithium metal foil segments to the substrate. The method also includes removing the intermediate carrier layer to form a lithium metal electrode comprising a plurality of thin lithium metal foil segments adhered to the substrate and separated from one another by designed gaps resulting from the predetermined intervals.

In some embodiments, the disclosed subject matter includes a lithium metal electrode that comprises a substrate, and a plurality of thin lithium metal foil segments adhered to the substrate and separated from one another by designed gaps, wherein the thin lithium metal foil segments are formed by compressing discrete lithium metal regions that were deposited onto an intermediate carrier layer at predetermined intervals prior to lamination onto the substrate. The thin lithium metal foil segments have a width and a thickness resulting from plastic deformation and elongation of the compressed discrete lithium metal regions, and the designed gaps result from the predetermined intervals.

In some embodiments, the disclosed subject matter includes a system for manufacturing a lithium metal electrode. The system includes a deposition device configured to deposit lithium metal onto an intermediate carrier layer to form discrete lithium metal regions positioned at predetermined intervals along the intermediate carrier layer. The system also includes a compression device configured to compress the discrete lithium metal regions via plastic deformation and elongation to form thin lithium metal foil segments on the intermediate carrier layer. The system further includes a lamination device configured to adhere the thin lithium metal foil segments to a substrate by passing the intermediate carrier layer, the thin lithium metal foil segments, and the substrate through the lamination device to produce a lithium metal electrode comprising a plurality of thin lithium metal foil segments adhered to the substrate and separated from one another by designed gaps resulting from the predetermined intervals.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a process flow diagram illustrating a conventional method for manufacturing a continuous intermittent lithium metal anode beginning with a lithium metal ingot in accordance with embodiments described herein;

FIG. 2 is a process flow diagram illustrating an example method for manufacturing a continuous intermittent lithium metal anode in accordance with embodiments described herein;

FIG. 3 is a diagram that illustrates a compression step in which a thick lithium metal piece is converted into thin lithium metal foil via elongation and plastic deformation in accordance with embodiments described herein;

FIG. 4 is a diagram that illustrates a compression step in which a thick and long lithium metal piece is converted into a thin and long lithium metal foil via elongation and plastic deformation in accordance with embodiments described herein;

FIG. 5 is a diagram that illustrates a compression step in which a thick and wide lithium metal piece is converted into a thin and wide lithium metal foil via elongation and plastic deformation in accordance with embodiments described herein;

FIG. 6 is a diagram that illustrates a compression step in which a thick, long, and wide lithium metal piece is converted into a thin, long, and wide lithium metal foil via elongation and plastic deformation in accordance with embodiments described herein; and

FIG. 7 is a diagram that illustrates a compression step in which multiple thick lithium metal pieces are contemporaneously converted into multiple thin lithium metal foil pieces with predetermined gaps between them via elongation and plastic deformation in accordance with embodiments described herein;

FIG. 8 is a side view schematic illustrating sequential compression and lamination steps that convert thick lithium metal into thin lithium metal foil adhered to a substrate in accordance with embodiments described herein;

FIG. 9 is an orthogonal view schematic illustrating sequential compression and lamination steps that convert thick lithium metal into thin lithium metal foil adhered to a substrate in accordance with embodiments described herein;

FIG. 10 is a top-down view depicting a final product comprising lithium metal foil segments intermittently laminated onto a substrate with designed positioning and spacing in accordance with embodiments described herein;

FIG. 11 is a graphical representation of voltage over time during a formation cycle for a coin cell assembled with a lithium metal anode manufactured using the disclosed method in accordance with embodiments described herein;

FIG. 12 is a graphical representation of charge/discharge efficiency and discharge specific capacity over two hundred cycles for a coin cell assembled with a lithium metal anode manufactured using the disclosed method in accordance with embodiments described herein;

FIG. 13 is a flow chart illustrating an example method for manufacturing a continuous intermittent lithium metal anode in accordance with embodiments described herein.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The present disclosure provides an improved manufacturing method for lithium metal electrodes that addresses several limitations associated with conventional lithium metal foil production techniques, particularly those based on lithium metal ingot extrusion processes. Conventional manufacturing approaches typically begin with a large lithium metal ingot that must be extruded under high pressure using hydraulic presses to produce thick lithium metal sheets, which are subsequently rolled multiple times to reduce thickness and produce lithium metal foil suitable for battery electrode fabrication. These traditional processes are energy intensive, require large manufacturing equipment, and often involve additional subsequent steps such as slitting and positioning of lithium metal foil pieces onto substrates. As a result, conventional lithium metal manufacturing methods can suffer from low material utilization, high production costs, and limited flexibility in electrode design.

The present disclosure introduces a fundamentally different approach to lithium metal electrode manufacturing by eliminating the need for large lithium metal ingots and continuous foil production followed by slitting operations. Instead, the disclosed method begins with lithium metal granules, pellets, or small lithium metal pieces, which may be more easily processed and handled compared with large lithium metal ingots. These lithium metal materials are heated and extruded to form a lithium metal wire, which serves as a feedstock for a controlled deposition process.

In some embodiments, the lithium metal wire is intermittently extruded, printed, or otherwise deposited onto an intermediate carrier layer, such as a polymer film, to form discrete lithium metal regions positioned at predetermined intervals along the intermediate carrier layer. The intermittent deposition process enables discrete lithium metal regions to be placed directly onto the intermediate carrier layer in patterns that correspond to desired electrode geometries. By depositing lithium metal in discrete regions rather than producing continuous lithium metal foil, the process enables the formation of patterned lithium metal structures without requiring subsequent slitting or cutting operations.

Following the intermittent deposition step, the discrete lithium metal regions are subjected to a compression process using rollers or other compressive devices. During compression, the discrete lithium metal regions undergo plastic deformation and elongation, particularly in the machine direction of the rollers. This compression process reduces the thickness of the discrete lithium metal regions while increasing their width, thereby transforming the discrete lithium metal regions into thin lithium metal foil segments having controlled dimensions. Because the discrete lithium metal regions were initially deposited at predetermined intervals, the compression process preserves designed gaps between adjacent thin lithium metal foil segments resulting from the predetermined intervals.

In some embodiments, the thin lithium metal foil segments are subsequently laminated onto a substrate using a continuous lamination process. The substrate may include, for example, a current collector such as copper foil or other conductive or structural materials used in battery electrode fabrication. During lamination, the thin lithium metal foil segments are pressed onto the substrate so that strong adhesion is formed between the thin lithium metal foil segments and the substrate. Following lamination, the intermediate carrier layer is removed, resulting in a lithium metal electrode comprising a plurality of thin lithium metal foil segments adhered to the substrate and separated from one another by designed gaps resulting from the predetermined intervals at which the discrete lithium metal regions were deposited onto the intermediate carrier layer.

The disclosed subject matter provides precise control over the final dimensions and placement of thin lithium metal foil segments. Parameters such as lithium metal segment length, width, thickness, and spacing can be engineered by adjusting deposition patterns, initial discrete lithium metal region dimensions, and compression conditions during rolling. As a result, the present disclosure enables improved design flexibility for lithium metal electrodes, allowing electrode architectures to be tailored to specific battery performance requirements.

The manufacturing process described herein provides several significant advantages over conventional lithium metal foil production methods. Because the process begins with lithium metal granules or small lithium metal pieces rather than large lithium metal ingots, the need for large hydraulic extrusion presses can be reduced or eliminated, which significantly decreases equipment size and manufacturing footprint. Material utilization can also be improved because the intermittent deposition process minimizes lithium metal waste that would otherwise remain within extrusion chambers or be removed during slitting operations. In addition, elimination of slitting and cutting steps simplifies the manufacturing workflow and can improve production throughput.

Furthermore, the intermittent deposition process provides a unique capability to create patterned lithium metal electrodes directly during manufacturing. By controlling the predetermined intervals between discrete lithium metal regions, the present disclosure enables electrode structures that may improve electrochemical performance, reduce lithium dendrite formation, and enhance electrolyte accessibility within battery cells. The ability to precisely position thin lithium metal foil segments on a substrate may also provide advantages for next generation battery designs that require customized electrode geometries.

Accordingly, the present disclosure provides a manufacturing method in which lithium metal is intermittently extruded, printed, or deposited onto an intermediate carrier layer to form discrete lithium metal regions positioned at predetermined intervals along the intermediate carrier layer, followed by compression and lamination steps that transform the discrete lithium metal regions into thin lithium metal foil segments adhered to a substrate. The process eliminates conventional slitting operations and enables precise control over lithium metal placement and geometry, resulting in a flexible and efficient manufacturing approach for lithium metal electrodes used in rechargeable battery systems.

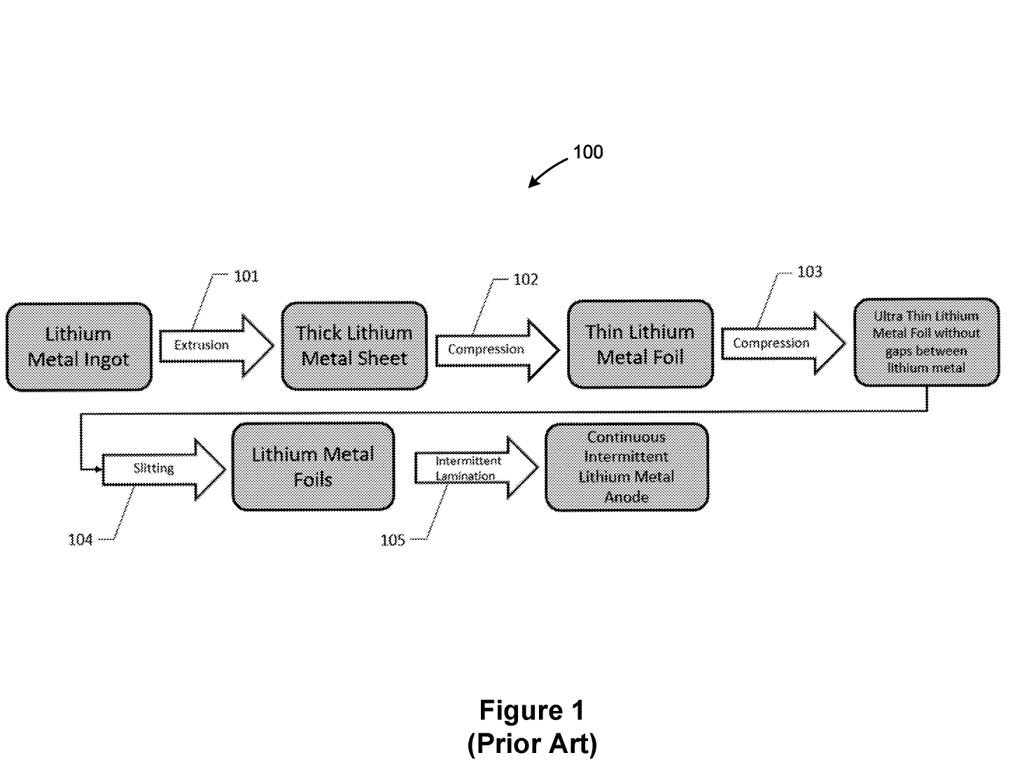

The following description sets forth specific embodiments of the present disclosure with reference to the accompanying drawings. FIG. 1 is a flow diagram illustrating a conventional process 100 for manufacturing a continuous intermittent lithium metal anode. Beginning with a lithium metal ingot, lithium is extruded (step 101) into a thick lithium metal sheet, then compressed via rollers multiple times. For example, the lithium may first be compressed (step 102) into a thin lithium metal foil, and then repeatedly compressed (step 103) until it becomes ultra-thin lithium metal foil. The resulting foil is one continuous length, with no intermittent gaps between lithium metal regions. This continuous foil then undergoes a slitting operation (step 104), which prepares the foil for lamination by cutting the continuous foil into individual pieces of lithium metal foil having desired dimensions. The individual pieces of lithium metal foil are finally intermittently laminated (step 105) with precise positioning onto a substrate at predetermined intervals, leaving designed gaps between adjacent lithium metal foil segments. In some embodiments, the substrate may include, for example, a current collector such as copper foil, stainless stee foil, nickel, aluminum, carbon sheets, or other electrically conductive or structural materials used in battery electrode fabrication. The final product is referred to as a "continuous intermittent lithium metal anode."

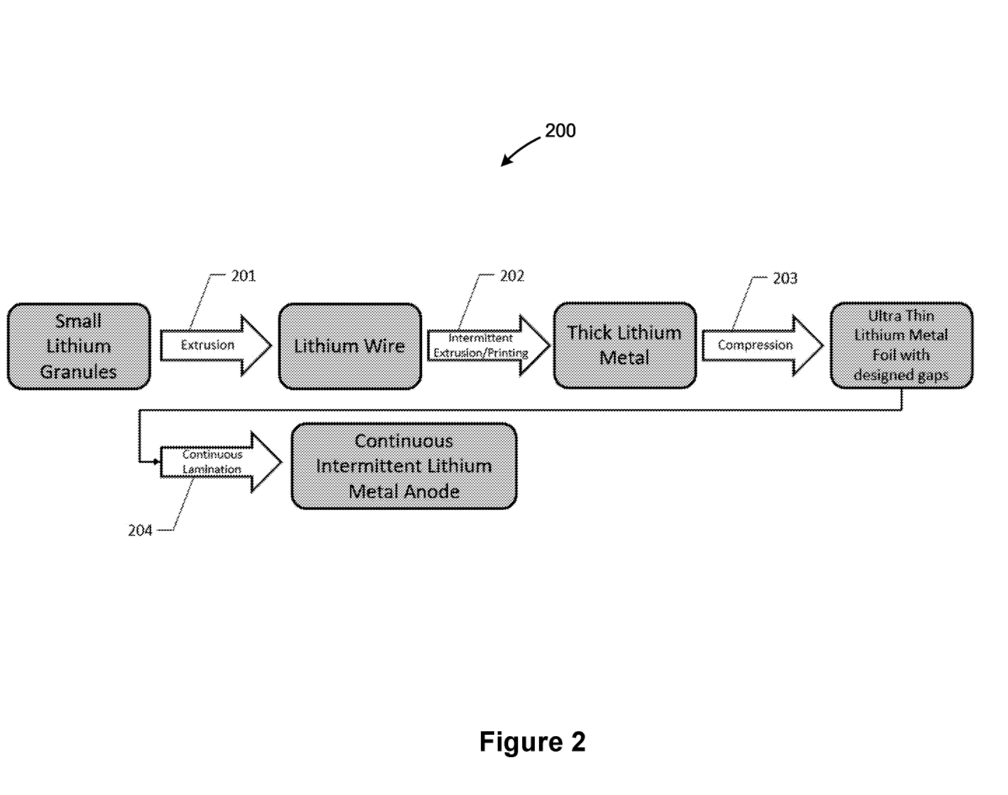

FIG. 2 is a flow diagram illustrating an exemplary process 200 for manufacturing a continuous intermittent lithium metal anode. In contrast to the conventional process 100 illustrated in FIG. 1, the proposed process 200 begins with lithium metal granules or lithium metal pieces rather than a large lithium metal ingot, thereby eliminating the ingot formation step required in the conventional process. Through heat and pressure, the lithium metal granules or lithium metal pieces may be extruded (step 201) into a lithium metal wire. The lithium metal wire then undergoes intermittent extrusion or printing (step 202) onto an intermediate carrier layer, such as a polymer film. This may include depositing discrete lithium metal regions positioned at predetermined intervals along the intermediate carrier layer. In some embodiments, a predetermined interval may include and/or be in a range between 10 millimeters (mm) and 100 mm. In some embodiments, the volume of lithium metal deposited in each discrete lithium metal region may be calculated and controlled prior to the compression step to achieve desired dimensions of the thin lithium metal foil segments and designed gaps in the final lithium metal electrode.

The discrete lithium metal regions may then undergo compression (step 203) via a plurality of rollers, which can convert the thick lithium metal regions into thin lithium metal foil segments via plastic deformation and elongation. Because the discrete lithium metal regions are deposited at predetermined intervals, the compression step preserves designed gaps between adjacent thin lithium metal foil segments. In some embodiments, a designed gap (i.e., the final gap between the lithium metal foil segments existing on the substrate) may include and/or be in a range between 30 mm and 40 mm. In alternative embodiments, the gap between the lithium metal foil segments may be less than 30 mm or greater than 40 mm. The resulting thin lithium metal foil segments are finally continuously laminated (step 204) onto a substrate, retaining the designed gaps between adjacent thin lithium metal foil segments. As in FIG. 1, the final product is referred to as a "continuous intermittent lithium metal anode." Notably, the proposed process does not require extrusion of a lithium metal ingot, which is widely accepted as a process involving major resource consumption.

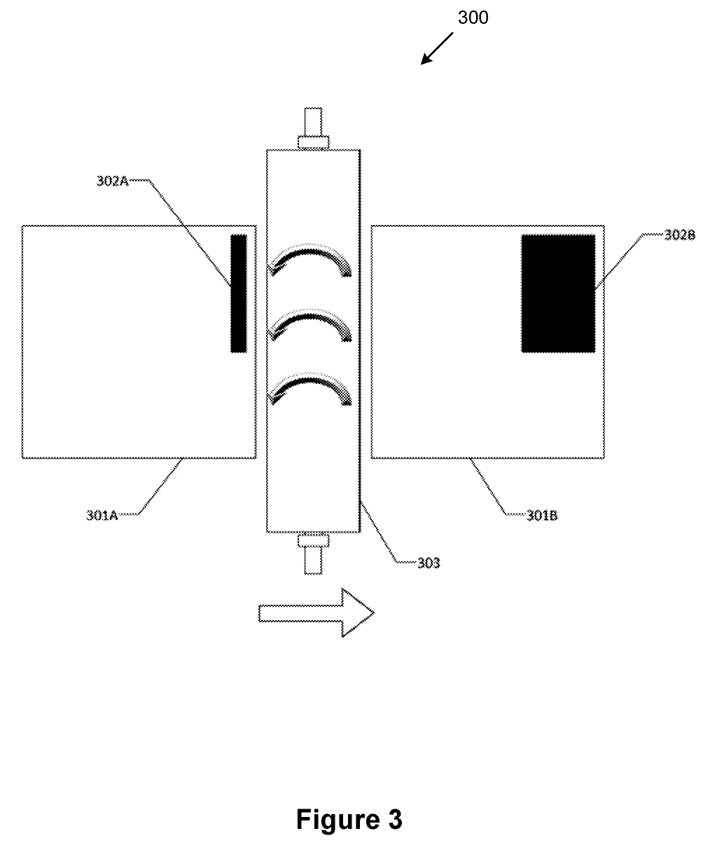

FIG. 3 illustrates a top-down view of a compression process 300 in which a discrete lithium metal region is compressed to form a thin lithium metal foil segment on an intermediate carrier layer. Prior to compression, a discrete lithium metal region 302A of predetermined dimensions is positioned between a first intermediate carrier layer (shown as 301A) and a second intermediate carrier layer (i.e., a temporary top covering layer that is not shown), such as a first polymer film and a second polymer film. Notably, the first intermediate carrier layer 301A temporarily supports the discrete lithium metal region 302A during the compression process 300. The first and second intermediate carrier layers and discrete lithium metal region 302A are passed together through a pair of rollers 303. During compression, the discrete lithium metal region undergoes plastic deformation and elongation in the machine direction of the pair of rollers, resulting in the formation of a thin lithium metal foil segment 302B. By controlling the applied roller pressure, thin lithium metal foil segments of designed width and thickness are produced. After the compression step, the thin lithium metal foil segment 302B remains on the first intermediate carrier layer 301B (which represents the first intermediate carrier layer 301A after it passes through rollers 303). In some embodiments, the dimensions of the thin lithium metal foil segment can be pre-selected by controlling the original dimensions of the discrete lithium metal region or the applied roller pressure.

In some embodiments, the intermittent extrusion or printing step 202 is performed by a deposition device configured to deposit lithium metal onto the intermediate carrier layer to form discrete lithium metal regions positioned at predetermined intervals along the intermediate carrier layer. In some embodiments, the compression step 203 is performed by a compression device configured to compress the discrete lithium metal regions via plastic deformation and elongation to form thin lithium metal foil segments on the intermediate carrier layer. In some embodiments, the lamination step 204 is performed by a lamination device configured to adhere the thin lithium metal foil segments to a substrate to produce a lithium metal electrode comprising a plurality of thin lithium metal foil segments adhered to the substrate and separated from one another by designed gaps resulting from the predetermined intervals.

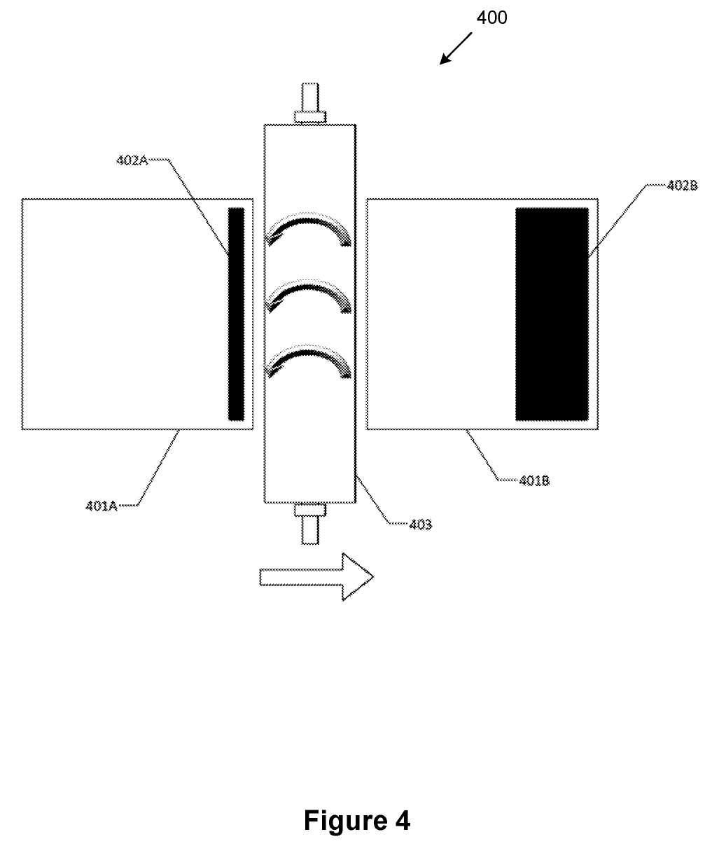

FIG. 4 illustrates a top-down view of a compression process 400 in which a discrete lithium metal region having a controlled length is compressed to form a thin lithium metal foil segment on an intermediate carrier layer. Prior to compression, a discrete lithium metal region 402A of predetermined dimensions, specifically having a controlled length, is positioned between a first intermediate carrier layer (shown as 401A) and a second intermediate carrier layer (i.e., a temporary top covering layer that is not shown), such as a first polymer film and a second polymer film. Notably, the first intermediate carrier layer 401A temporarily supports the discrete lithium metal region 402A during the compression process 400. The first and second intermediate carrier layers and discrete lithium metal region 402A are passed together through a pair of rollers 403. During compression, the discrete lithium metal region undergoes plastic deformation and elongation in the machine direction of the pair of rollers, resulting in the formation of a thin lithium metal foil segment 402B. Notably, the compression process preserves the length of the discrete lithium metal region, such that plastic deformation and elongation caused by the pair of rollers alters only the width and thickness of the discrete lithium metal region, resulting in a thin lithium metal foil segment 402B that retains the length of the original discrete lithium metal region 402A but has an increased width and reduced thickness. After the compression step, the thin lithium metal foil segment 402B remains on the first intermediate carrier layer 401B (which represents the first intermediate carrier layer 401A after it passes through rollers 403). In some embodiments, the dimensions of the thin lithium metal foil segment can be pre-selected by controlling the original dimensions of the discrete lithium metal region or the applied roller pressure.

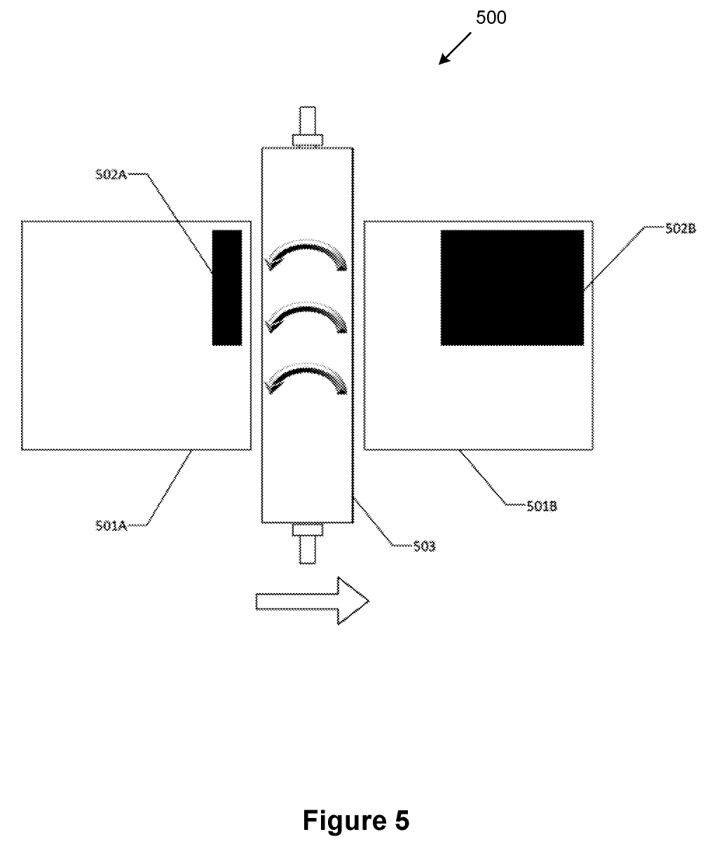

FIG. 5 illustrates a top-down view of a compression process 500 in which a discrete lithium metal region having a controlled width is compressed to form a thin lithium metal foil segment on an intermediate carrier layer. Prior to compression, a discrete lithium metal region 502A of predetermined dimensions, specifically having a controlled width, is positioned between a first intermediate carrier layer (shown as 501A) and a second intermediate carrier layer (i.e., a temporary top covering layer that is not shown), such as a first polymer film and a second polymer film. Notably, the first intermediate carrier layer 501A temporarily supports the discrete lithium metal region 502A during the compression process 500. The first and second intermediate carrier layers and discrete lithium metal region 502A are passed together through a pair of rollers 503. During compression, the discrete lithium metal region undergoes plastic deformation and elongation in the machine direction of the pair of rollers, resulting in the formation of a thin lithium metal foil segment 502B. Notably, because the discrete lithium metal region undergoes elongation in the machine direction of the pair of rollers, beginning with a discrete lithium metal region 502A having a greater width results in a thin lithium metal foil segment 502B having a correspondingly greater width, and vice versa. Thus, the width of the resulting thin lithium metal foil segment can be precisely controlled by adjusting the width of the original discrete lithium metal region. After the compression step, the thin lithium metal foil segment 502B remains on the first intermediate carrier layer 501B (which represents the first intermediate carrier layer 501A after it passes through rollers 503). In some embodiments, the dimensions of the thin lithium metal foil segment can be pre-selected by controlling the original dimensions of the discrete lithium metal region or the applied roller pressure.

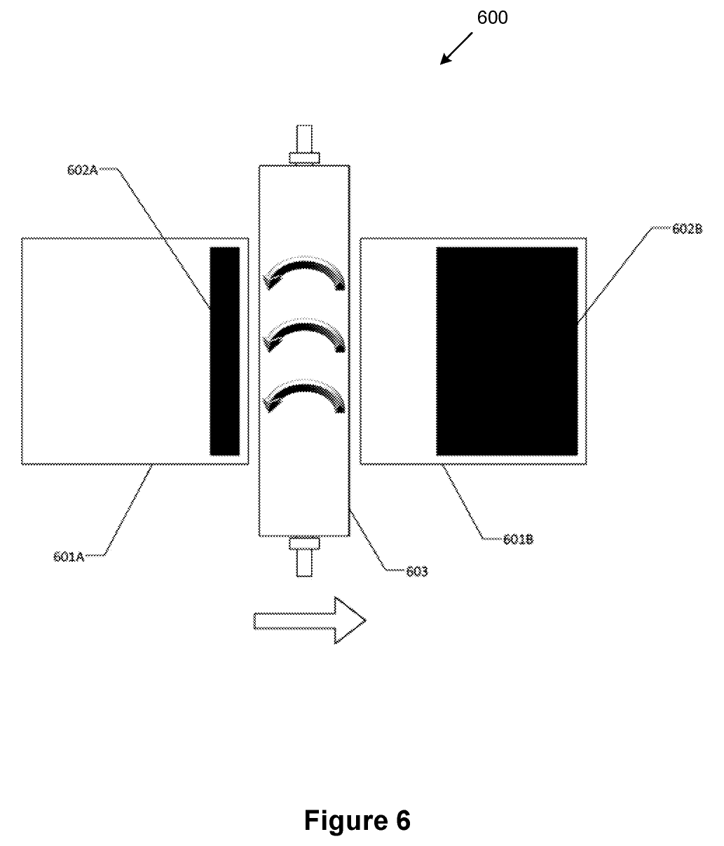

FIG. 6 illustrates a top-down view of a compression process 600 in which a discrete lithium metal region having a controlled length and a controlled width is compressed to form a thin lithium metal foil segment on an intermediate carrier layer. Prior to compression, a discrete lithium metal region 602A of predetermined dimensions, specifically having a controlled length and a controlled width, is positioned between a first intermediate carrier layer (shown as 601A) and a second intermediate carrier layer (i.e., a temporary top covering layer that is not shown), such as a first polymer film and a second polymer film. Notably, the first intermediate carrier layer 601A temporarily supports the discrete lithium metal region 602A during the compression process 600. The first and second intermediate carrier layers and discrete lithium metal region 602A are passed together through a pair of rollers 603. During compression, the discrete lithium metal region undergoes plastic deformation and elongation in the machine direction of the pair of rollers, resulting in the formation of a thin lithium metal foil segment 602B. Notably, FIG. 6 combines the processes illustrated in FIGS. 4 and 5, demonstrating that both the length and width of the resulting thin lithium metal foil segment 602B can be precisely controlled by adjusting the corresponding dimensions of the original discrete lithium metal region 602A. After the compression step, the thin lithium metal foil segment 602B remains on the first intermediate carrier layer 601B (which represents the first intermediate carrier layer 601A after it passes through rollers 603). In some embodiments, the dimensions of the thin lithium metal foil segment can be pre-selected by controlling the original dimensions of the discrete lithium metal region or the applied roller pressure.

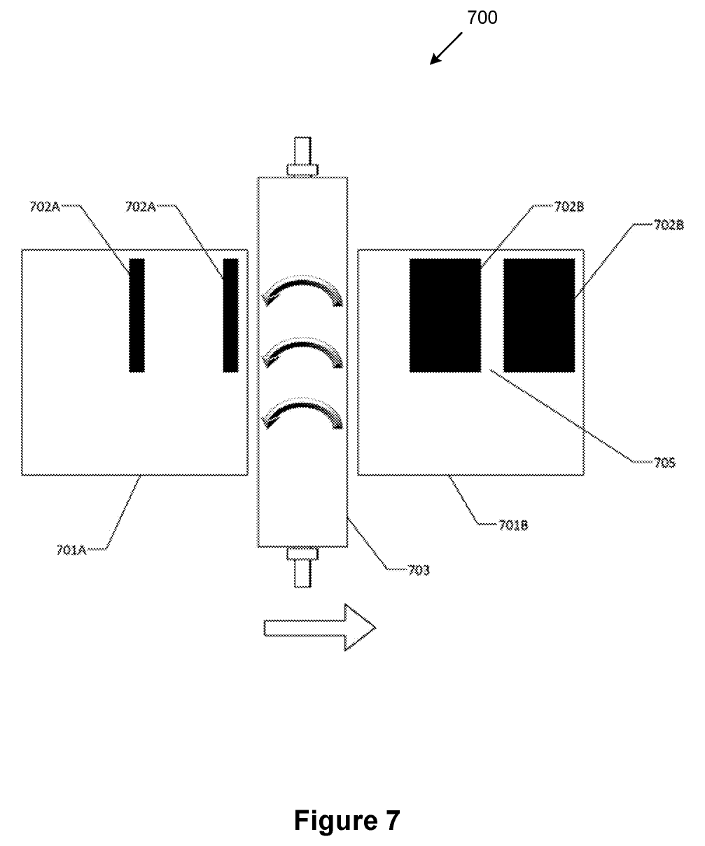

FIG. 7 illustrates a top-down view of a compression process 700 in which a plurality of discrete lithium metal regions are compressed simultaneously to form a plurality of thin lithium metal foil segments on an intermediate carrier layer. Prior to compression, a plurality of discrete lithium metal regions 702A of predetermined dimensions are precisely positioned between a first intermediate carrier layer (shown as 701A) and a second intermediate carrier layer (not shown), such as a first polymer film and a second polymer film. Notably, the first intermediate carrier layer 701A temporarily supports the plurality of discrete lithium metal regions 702A during the compression process 700. The first and second intermediate carrier layers and plurality of discrete lithium metal regions 702A are passed together through a pair of rollers 703. During compression, the plurality of discrete lithium metal regions undergo plastic deformation and elongation in the machine direction of the pair of rollers, resulting in the formation of a plurality of thin lithium metal foil segments 702B of designed length, width, and thickness. Notably, the plurality of discrete lithium metal regions 702A are positioned at predetermined intervals along the first intermediate carrier layer 701A, such that the compression process preserves designed gaps 705 between adjacent thin lithium metal foil segments 702B resulting from the predetermined intervals. After the compression step, the plurality of thin lithium metal foil segments 702B remain on the first intermediate carrier layer 701B (which represents the first intermediate carrier layer 701A after it passes through rollers 703). In some embodiments, this process allows for the repeatable production of thin lithium metal foil segments of designed dimensions and designed gaps in placement, yielding a plurality of thin lithium metal foil segments arranged in sequential patterns along the first intermediate carrier layer.

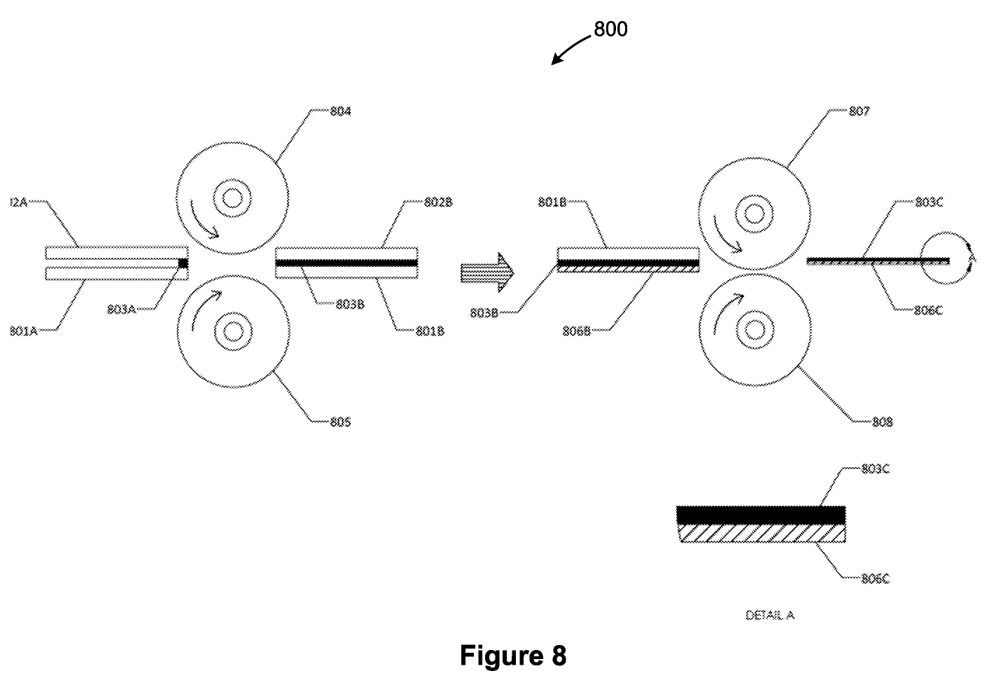

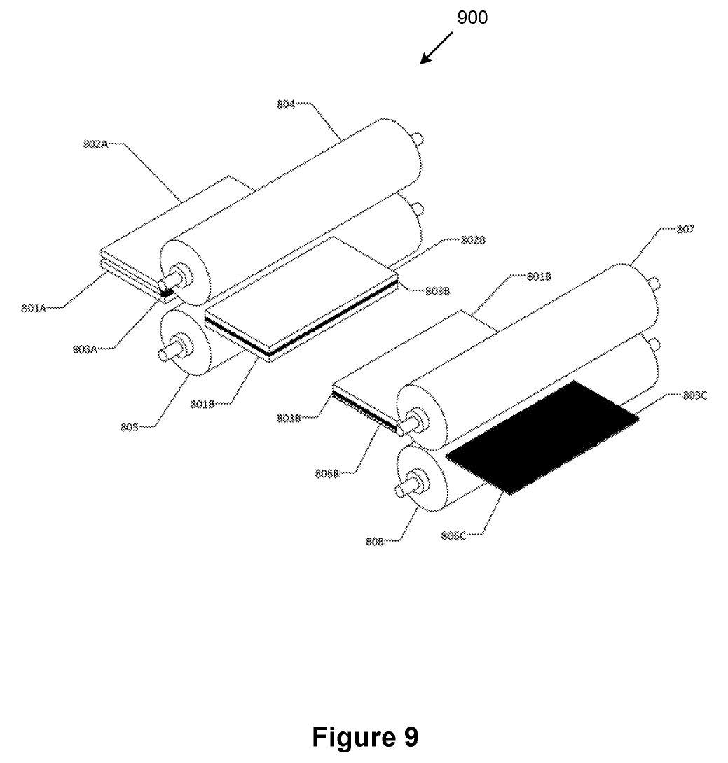

As described above with respect to FIG. 2, in some embodiments the compression and lamination process 800 is performed as part of a system comprising a deposition device, a compression device, and a lamination device. The deposition device is configured to deposit lithium metal onto the intermediate carrier layer to form discrete lithium metal regions positioned at predetermined intervals along the intermediate carrier layer as described with respect to step 202 of FIG. 2. The compression and lamination steps of the system are described in detail below with respect to FIGS. 8 and 9. FIG. 8 depicts a side view of a compression and lamination process 800 that produces thin lithium metal foil segments from discrete lithium metal regions and laminates the thin lithium metal foil segments onto a substrate to form a lithium metal electrode. FIG. 9 depicts an orthogonal view of the same compression and lamination process 800. The following description applies to both figures.

One or more discrete lithium metal regions 803A enter the compression process supported between a first intermediate carrier layer 801A positioned below the discrete lithium metal regions 803A and a second intermediate carrier layer 802A positioned above the discrete lithium metal regions 803A. In some embodiments, first intermediate carrier layer 801A and second intermediate carrier layer 802A may include a first polymer film and a second polymer film, respectively. Notably, the first intermediate carrier layer 801A may be positioned such that a rough side of the first intermediate carrier layer faces the discrete lithium metal regions 803A. The first and second intermediate carrier layers and discrete lithium metal regions 803A are passed together through a first pair of rollers (e.g., top roller 804 and bottom roller 805), causing the discrete lithium metal regions to undergo plastic deformation and elongation in the machine direction of the first pair of rollers. This compression process increases the width and decreases the thickness of the discrete lithium metal regions, resulting in the formation of thin lithium metal foil segments 803B remaining between the unchanged first intermediate carrier layer 801B and the unchanged second intermediate carrier layer 802B. Due to the compression forces and the interaction between the thin lithium metal foil segments 803B and the rough surface of the first intermediate carrier layer 801B, the thin lithium metal foil segments 803B temporarily adhere to the first intermediate carrier layer 801B. This temporary adherence allows the second intermediate carrier layer 802B to be subsequently removed and replaced with a substrate 806B, such as a current collector (e.g., copper foil) configured for use in a battery electrode.

To prepare for lamination, the three-material stack comprising the first intermediate carrier layer 801B, thin lithium metal foil segments 803B, and substrate 806B is flipped (e.g., axially rotated 180 degrees), causing the top-down layer order to become the first intermediate carrier layer 801B, the thin lithium metal foil segments 803B, and a substrate 806B (which was introduced in place of the removed second intermediate carrier layer 802B). The assembly is passed through a second pair of rollers (e.g., a top roller 807 and a bottom roller 808), resulting in a further decrease in thickness of the thin lithium metal foil segments and strong adherence of the thin lithium metal foil segments 803C to the substrate 806C. Detail A depicts a cross-sectional view of the resulting layered structure comprising the thin lithium metal foil segments 803C strongly adhered to the substrate 806C. Notably, the first intermediate carrier layer 801B is removed from the top of the thin lithium metal foil segments 803B, resulting in a final product of exposed thin lithium metal foil segments 803C strongly adhered to the substrate 806C, referred to herein as a lithium metal electrode (e.g., a lithium metal anode).

Notably, the compression and lamination process 800 depicted in FIG. 8 (i.e., process 900 depicted in FIG. 9) is configured to allow for continuous lamination of thin lithium metal foil segments with designed gaps. By utilizing the physical properties of the thin lithium metal foil segments and the first intermediate carrier layer to cause temporary adherence, the process preserves any designed gaps produced during the compression of a plurality of discrete lithium metal regions as illustrated in FIG. 7, in which a plurality of discrete lithium metal regions 702A are positioned at predetermined intervals along the first intermediate carrier layer 701A. The result is a lithium metal electrode comprising a plurality of thin lithium metal foil segments 803C adhered to the substrate 806C and separated from one another by designed gaps resulting from the predetermined intervals at which the discrete lithium metal regions were deposited onto the intermediate carrier layer.

FIG. 9 depicts an orthogonal view of the compression and lamination process 800 (which is identified as process 900 in FIG. 9) described above with respect to FIG. 8. As shown in FIG. 9, the first intermediate carrier layer 801A, second intermediate carrier layer 802A, and discrete lithium metal regions 803A are fed together from supply rolls through a first pair of rollers (i.e., top roller 804 and bottom roller 805) to produce thin lithium metal foil segments 803B on the unchanged first intermediate carrier layer 801B. The second intermediate carrier layer 802B is removed and replaced with a substrate 806B, and the three-material stack is flipped (e.g., axially rotated 180 degrees) and passed through a second pair of rollers (e.g., top roller 807 and bottom roller 808) to produce a lithium metal electrode comprising thin lithium metal foil segments 803C that are strongly adhered to the substrate 806C. The first intermediate carrier layer is then removed, resulting in a finished lithium metal electrode comprising thin lithium metal foil segments 803C adhered to the substrate 806C and separated from one another by designed gaps resulting from the predetermined intervals at which the discrete lithium metal regions were deposited onto the intermediate carrier layer.

In some embodiments, the dimensions of the thin lithium metal foil segments and the designed gaps between adjacent thin lithium metal foil segments may be controlled by adjusting one or more of the thickness of the discrete lithium metal regions prior to compression and the gap between the rollers during compression. For example, a narrower gap between the rollers during compression may result in greater elongation of the discrete lithium metal regions, which in turn affects the dimensions of the resulting thin lithium metal foil segments and the designed gaps between adjacent segments.

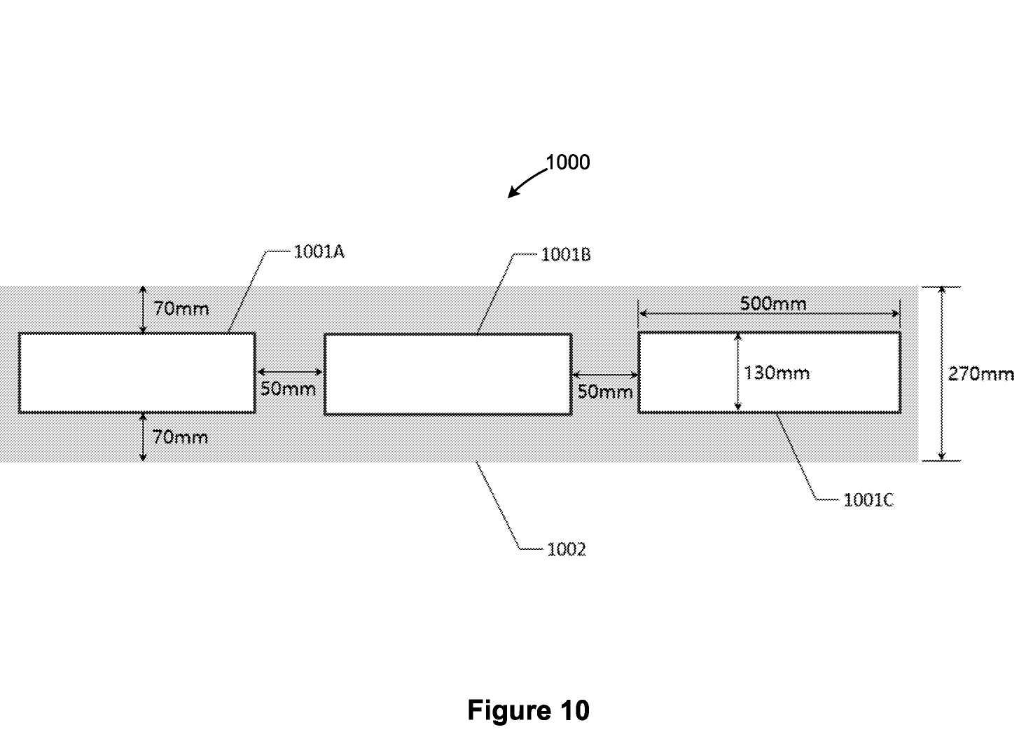

FIG. 10 depicts a top-down view of a final product example comprising a lithium metal electrode 1000 in which a plurality of thin lithium metal foil segments are intermittently laminated onto a substrate. In the illustrated embodiment, three thin lithium metal foil segments 1001A, 1001B, and 1001C are precisely positioned and spaced on a substrate 1002. Each thin lithium metal foil segment has a width of approximately 130 mm and a length of approximately 500 mm. The thin lithium metal foil segments are separated from one another by designed gaps of approximately 50 mm and are positioned approximately 70 mm from each end of the substrate along its length. The substrate 1002 has a width of approximately 270 mm. Although the disclosure describes and illustrates specific dimensions of the substrate and foil segments, these components may have other dimensions without departing from the scope of the disclosed subject matter. Notably, the designed gaps between adjacent thin lithium metal foil segments and the placement of the thin lithium metal foil segments on the substrate 1002 are explicitly controlled by design, resulting from the predetermined intervals at which the discrete lithium metal regions were deposited onto the intermediate carrier layer prior to compression and lamination.

The lithium metal electrode 1000 depicted in FIG. 10 represents a product embodiment of the present disclosure. The lithium metal electrode 1000 comprises a substrate 1002 and a plurality of thin lithium metal foil segments 1001A, 1001B, and 1001C adhered to the substrate 1002 and separated from one another by designed gaps as described above. The thin lithium metal foil segments 1001A, 1001B, and 1001C have a width and a thickness resulting from plastic deformation and elongation of the discrete lithium metal regions during the compression process. In some embodiments, the thin lithium metal foil segments are arranged in a repeating pattern along the substrate 1002 as shown. In some embodiments, the thin lithium metal foil segments have a thickness of less than 100 µm. In some embodiments, the thin lithium metal foil segments are formed by compressing discrete lithium metal regions that were deposited onto the intermediate carrier layer through an intermittent extrusion process, a printing process, or an additive manufacturing process prior to lamination onto the substrate 1002.

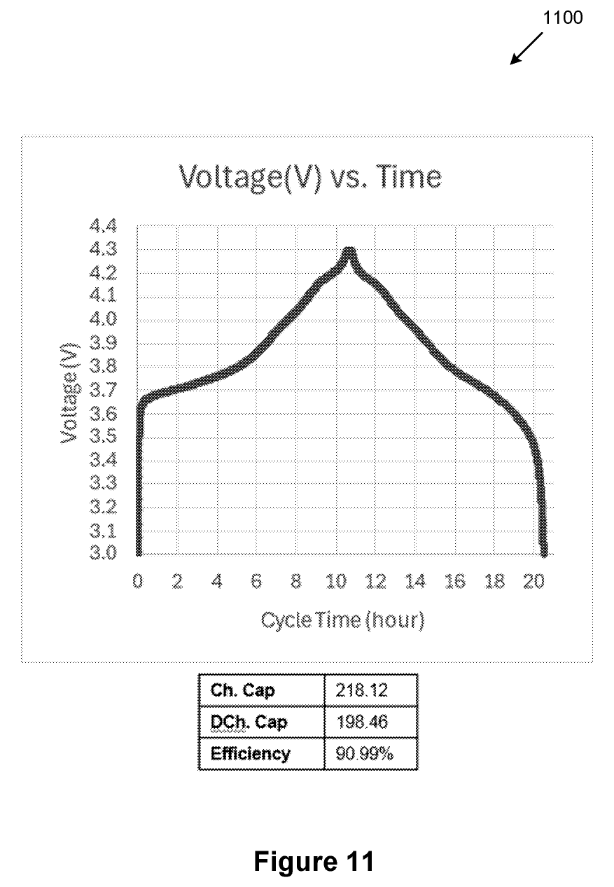

FIG. 11 is a graphical representation 1100 of the electrochemical performance of a battery cell assembled using a lithium metal electrode produced according to the disclosed process. Specifically, FIG. 11 depicts voltage behavior during a formation cycle for a coin cell comprising a lithium metal electrode manufactured using the compression and lamination process described herein. The formation cycle was conducted at a charge/discharge rate of 0.1C, wherein the C-rate refers to the rate of charge or discharge relative to the total capacity of the battery cell, such that a rate of 0.1C corresponds to a full charge or discharge over approximately 10 hours. During the formation cycle, the voltage increases from approximately 3.0 V to approximately 4.3 V during charging and then decreases back to approximately 3.0 V during discharge over a total cycle time of approximately 20 hours. The measured charge capacity is approximately 218.12 mAh per gram and the discharge capacity is approximately 198.46 mAh per gram, resulting in a coulombic efficiency of approximately 90.99 percent.

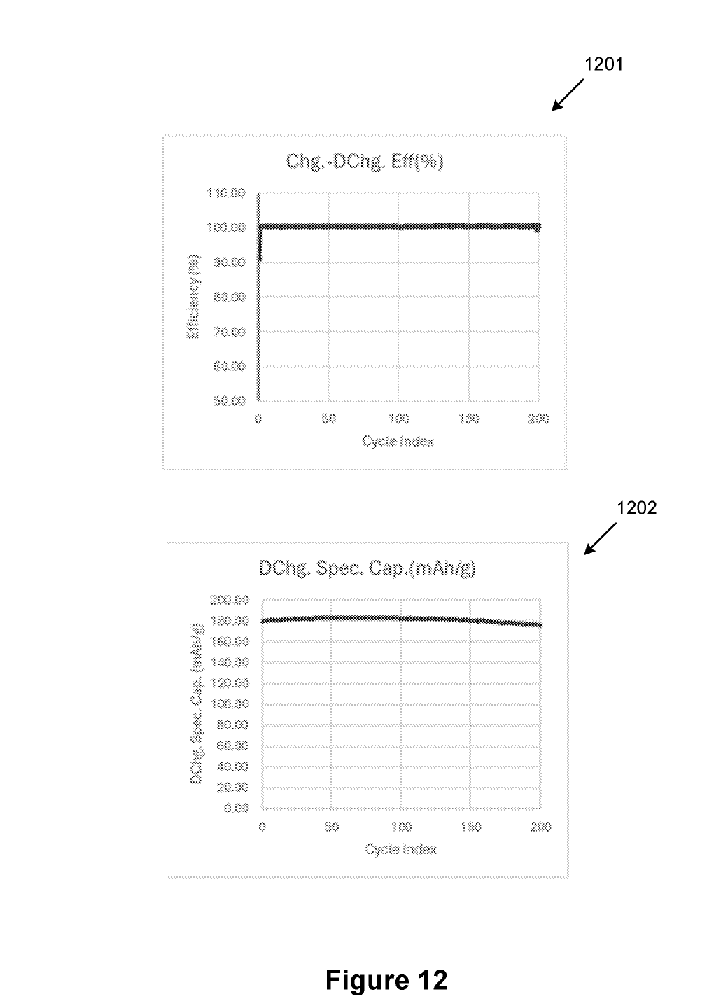

FIG. 12 illustrates long term cycling performance of battery cells manufactured using a lithium metal electrode produced according to the disclosed process. FIG. 12 comprises a first graph 1201 depicting charge/discharge efficiency and a second graph 1202 depicting discharge specific capacity, each measured over two hundred charge/discharge cycles. The cycling test was conducted at a charge rate of 4C and a discharge rate of 1C, wherein a charge rate of 4C corresponds to a full charge over approximately 15 minutes and a discharge rate of 1C corresponds to a full discharge over approximately 1 hour. As shown in graph 1201, the charge/discharge efficiency remains approximately 100 percent throughout the two hundred cycles. As shown in graph 1202, the discharge specific capacity remains approximately 180 mAh per gram throughout the two hundred cycles. These results demonstrate that lithium metal electrodes produced using the compression and lamination process described herein exhibit electrochemical performance comparable to lithium metal electrodes produced using conventional manufacturing techniques.

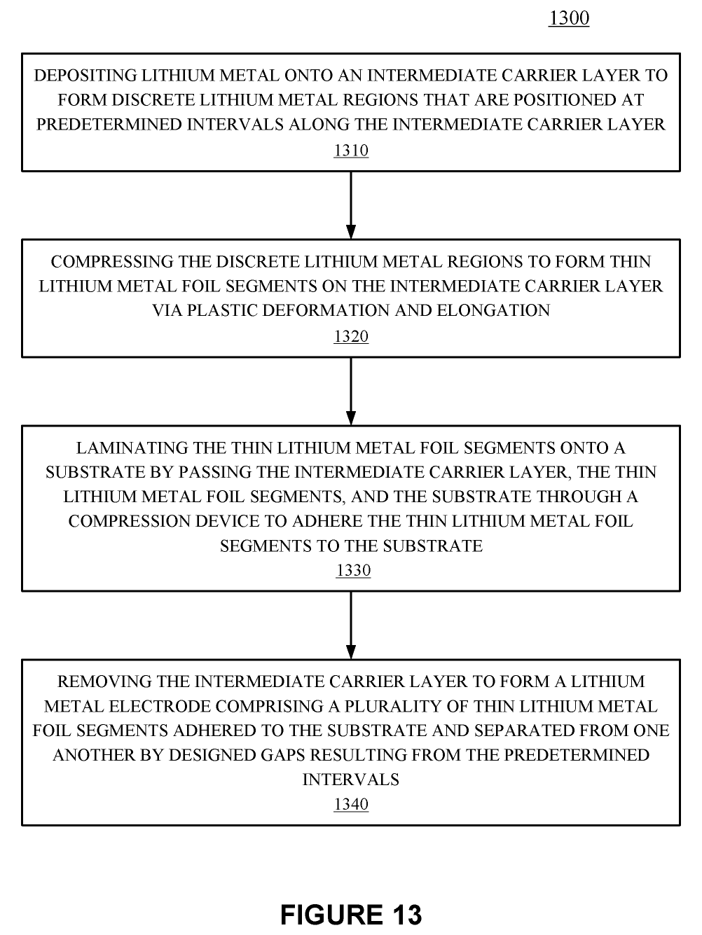

FIG. 13 is a flow chart illustrating a method 1300 for manufacturing a lithium metal electrode according to the present disclosure. As shown in FIG. 13, the method 1300 comprises a set of steps that correspond to the compression and lamination process described herein with respect to FIGS. 1 through 12.

In step 1310, lithium metal is deposited onto an intermediate carrier layer to form discrete lithium metal regions that are positioned at predetermined intervals along the intermediate carrier layer. In some embodiments, the lithium metal used in the depositing step originates from lithium metal granules or lithium metal pieces. In some such embodiments, the lithium metal granules or lithium metal pieces are heated and extruded to form a lithium metal wire prior to the depositing step. In some embodiments, the intermediate carrier layer comprises a continuous film, and the discrete lithium metal regions are deposited onto the continuous film at the predetermined intervals along a length of the continuous film. In some embodiments, the intermediate carrier layer comprises a polymer film that temporarily supports the discrete lithium metal regions during processing. In some embodiments, the depositing step comprises intermittently extruding the lithium metal onto the intermediate carrier layer. In some embodiments, the depositing step comprises printing the lithium metal onto the intermediate carrier layer. In some embodiments, the depositing step comprises depositing the lithium metal onto the intermediate carrier layer using an additive manufacturing process.

In step 1320, the discrete lithium metal regions are compressed to form thin lithium metal foil segments on the intermediate carrier layer via plastic deformation and elongation. In some embodiments, the compressing step comprises passing the discrete lithium metal regions between a pair of rollers. In some such embodiments, compressing the discrete lithium metal regions causes the discrete lithium metal regions to elongate in a machine direction of the pair of rollers. In some embodiments, compressing the discrete lithium metal regions reduces a thickness of the discrete lithium metal regions while increasing a width of the discrete lithium metal regions. In some embodiments, a plurality of the discrete lithium metal regions is compressed simultaneously, thereby producing a plurality of thin lithium metal foil segments in a single compression step.

In step 1330, the thin lithium metal foil segments are laminated onto a substrate by passing the intermediate carrier layer, the thin lithium metal foil segments, and the substrate through a compression device to adhere the thin lithium metal foil segments to the substrate. In some embodiments, the laminating step comprises passing the intermediate carrier layer, the thin lithium metal foil segments, and the substrate through a pair of rollers. In some embodiments, the substrate comprises a current collector configured for use in a battery electrode. In some such embodiments, the current collector comprises copper foil.

In step 1340, the intermediate carrier layer is removed to form a lithium metal electrode comprising a plurality of thin lithium metal foil segments adhered to the substrate and separated from one another by designed gaps resulting from the predetermined intervals at which the discrete lithium metal regions were deposited onto the intermediate carrier layer in step 1310.

In some embodiments, a plurality of lithium metal regions may be formed on a surface such that the lithium metal regions are spatially separated by predefined gaps. The lithium metal regions may then be subjected to a deformation process that reduces the thickness of the lithium metal regions to form lithium metal foil segments. The lithium metal foil segments may then be disposed onto a substrate such that gaps between adjacent lithium metal foil segments in the final lithium metal electrode result from the predefined gaps between the lithium metal regions prior to the deformation process. In some such embodiments, the predefined gaps between adjacent lithium metal regions may be selected to account for dimensional changes in the lithium metal regions resulting from the deformation process, such that the gaps between adjacent lithium metal foil segments after deformation correspond to desired designed gaps in the final lithium metal electrode. In some embodiments, the dimensions of the lithium metal foil segments and the designed gaps between adjacent lithium metal foil segments may be controlled by adjusting one or more of the thickness of the lithium metal regions prior to the deformation process and the gap between rollers during the deformation process. In some embodiments, the volume of lithium metal in each lithium metal region may be calculated and controlled prior to the deformation process to achieve desired dimensions of the lithium metal foil segments and designed gaps in the final lithium metal electrode. In some embodiments, the deformation process may comprise a rolling, pressing, or other compressive process that reduces the thickness of the lithium metal regions while transforming them into lithium metal foil segments suitable for use in a battery electrode.

The present disclosure described herein therefore provides a manufacturing approach in which lithium metal is intermittently extruded, printed, or deposited onto an intermediate carrier layer to form discrete lithium metal regions positioned at predetermined intervals along the intermediate carrier layer. The discrete lithium metal regions are subsequently compressed to form thin lithium metal foil segments via plastic deformation and elongation, and laminated onto a substrate while preserving designed gaps between adjacent thin lithium metal foil segments resulting from the predetermined intervals. This manufacturing approach eliminates slitting operations, reduces energy consumption associated with lithium metal ingot extrusion, and enables improved flexibility in lithium metal electrode design for battery applications.

The embodiments shown and described in the preceding description are for illustration and explanation only and are not intended to limit the scope of the disclosed subject matter as set forth in the appended claims.

What is claimed is:

1. A method for manufacturing a lithium metal electrode, comprising:
depositing lithium metal onto an intermediate carrier layer to form discrete lithium metal regions that are positioned at predetermined intervals along the intermediate carrier layer;
compressing the discrete lithium metal regions to form thin lithium metal foil segments on the intermediate carrier layer via plastic deformation and elongation;
laminating the thin lithium metal foil segments onto a substrate by passing the intermediate carrier layer, the thin lithium metal foil segments, and the substrate through a compression device to adhere the thin lithium metal foil segments to the substrate; and
removing the intermediate carrier layer to form a lithium metal electrode comprising a plurality of thin lithium metal foil segments adhered to the substrate and separated from one another by designed gaps resulting from the predetermined intervals.

2. The method of claim 1, wherein depositing the lithium metal comprises intermittently extruding the lithium metal onto the intermediate carrier layer.

3. The method of claim 1, wherein depositing the lithium metal comprises printing the lithium metal onto the intermediate carrier layer.

4. The method of claim 1, wherein depositing the lithium metal comprises depositing the lithium metal using an additive manufacturing process.

5. The method of claim 1, wherein the intermediate carrier layer comprises a continuous film, and wherein the discrete lithium metal regions are deposited onto the continuous film at the predetermined intervals along a length of the continuous film.

6. The method of claim 1, wherein the intermediate carrier layer comprises a polymer film that temporarily supports the lithium metal during processing.

7. The method of claim 1, wherein compressing the discrete lithium metal regions comprises passing the discrete lithium metal regions between a pair of rollers.

8. The method of claim 7, wherein compressing the discrete lithium metal regions causes the discrete lithium metal regions to elongate in a machine direction of the pair of rollers.

9. The method of claim 1, wherein compressing the discrete lithium metal regions reduces a thickness of the discrete lithium metal regions while increasing a width of the discrete lithium metal regions.

10. The method of claim 1, wherein a plurality of the discrete lithium metal regions is compressed simultaneously.

11. The method of claim 1, wherein the lithium metal segments are laminated onto the substrate using a rolling lamination process.

12. The method of claim 1, wherein the substrate comprises a current collector configured for use in a battery electrode.

13. The method of claim 12, wherein the current collector comprises copper foil.

14. The method of claim 1, wherein lithium metal used in the depositing step originates from lithium metal granules or lithium metal pieces.

15. The method of claim 14 further comprising heating and extruding the lithium metal granules or the lithium metal pieces to form the lithium metal.

16. A lithium metal electrode, comprising:
a substrate; and
a plurality of thin lithium metal foil segments adhered to the substrate and separated from one another by designed gaps;
wherein the thin lithium metal foil segments are formed by compressing discrete lithium metal regions that were deposited onto an intermediate carrier layer at predetermined intervals prior to lamination onto the substrate;
wherein the thin lithium metal foil segments have a width and a thickness resulting from plastic deformation and elongation of the compressed discrete lithium metal regions; and
wherein the designed gaps result from the predetermined intervals.

17. The lithium metal electrode of claim 16, wherein the thin lithium metal foil segments are arranged in a repeating pattern along the substrate.

18. The lithium metal electrode of claim 16, wherein the thin lithium metal foil segments have a thickness of less than 100 µm.

19. The lithium metal electrode of claim 16, wherein the thin lithium metal foil segments are formed by compressing discrete lithium metal regions that were deposited onto the intermediate carrier layer through an intermittent extrusion process, a printing process, or an additive manufacturing process.

20. A system for manufacturing a lithium metal electrode, comprising:
a deposition device configured to deposit lithium metal onto an intermediate carrier layer to form discrete lithium metal regions positioned at predetermined intervals along the intermediate carrier layer;
a compression device configured to compress the discrete lithium metal regions via plastic deformation and elongation to form thin lithium metal foil segments on the intermediate carrier layer; and
a lamination device configured to adhere the thin lithium metal foil segments to a substrate by passing the intermediate carrier layer, the thin lithium metal foil segments, and the substrate through the lamination device to produce a lithium metal electrode comprising a plurality of thin lithium metal foil segments adhered to the substrate and separated from one another by designed gaps resulting from the predetermined intervals.
